(19) United States
(12) Patent Application Publication
(10) Pub. No.: US 2008/0291075 A1
(43) Pub. Date: Nov. 27, 2008

(54) Vehicle-network defensive aids suite

(76) Inventor: John Rapanotti, Quebec (CA)

Correspondence Address: GEORGE A. SEABY;SEABY & ASSOCIATES, 250 CITY CENTRE AVNUE, OTTAWA, ON, K1R6K7, CA

(21) Appl. No.: 11/802,817

(22) Filed: May 25, 2007

(51) Int. Cl. G01S 7/02; F41C 27/06; F41G 5/08; G01V 1/18; F42B 12/00; G01S 13/00

(52) U.S. Cl. 342/20; 102/482; 342/53; 367/178; 42/105; 89/41.07

(57) ABSTRACT

A defensive aids suite for light armored vehicles utilizes four complementary sensor technologies including: visible and infrared optics, radar, acoustics and both laser and millimeter wave detection. Targeting and maneuvering optics are used for long-range threat detection with obscuration grenades and vehicle countermaneuvers being used to avoid a threat. Short range search and track radar is used with explosive or fragmentation grenades selected and launched to intercept and defeat the threat. Acoustic threat detection increases robustness and extends the detection range to include small calibers threats. Detection of active targeting systems by laser and radar warning receivers provides cueing information for targeting optics and fire control systems.

### FIELD OF THE INVENTION

This present invention relates to a system for defending light armored vehicles, and in particular to a defensive aids suite (DAS) for such vehicles.

### DESCRIPTION OF RELATED ART

Modern weapons have reduced the effectiveness of passive armor on land vehicles. Portable missiles with warheads containing shaped charges can penetrate any thickness of armor. Sensor-fused munitions and top-attack missiles are designed to penetrate the more vulnerable top of the turret. Artillery, instead of rocket motors, can be used to launch missiles that cannot be detected by sensors designed to detect rocket plumes. Light armored vehicles (LAVs) have been developed to operate in this environment with a minimal amount of passive armor and increased emphasis on improved situational awareness based on sensors, computers and countermeasures to detect and react to threats. While meeting the requirements of rapid deployment and operations other than war, LAVs have further evolved into vehicle networks through improved computing and digital communications to make more efficient use of the information processed from vehicle sensors.

Survivability depends, inter alia, on remaining undetected by using camouflage and by reducing vehicle signatures to background levels. Survivability can be further increased by the early detection of threats followed by appropriate and timely countermeasures to either defeat the threat directly or to reduce the effectiveness of the threat guidance system. Threat destruction becomes essential when avoidance is impossible. At 2-3 m from a vehicle, missiles, rockets and gun rounds can be defeated by (i) passive armor, (ii) explosive reactive armor and (iii) a sensor-fused shaped charge, at 50 m from the vehicle (iv) an intercepting grenade can be used, and beyond 50 m (v) a laser-based weapon is effective. The velocity of the threat and the short distance to the vehicle results in a very short timeline. Once the velocity and angle of arrival are determined, an automated response energizes and launches intercepting devices. U.S. Pat. No. 6,717,543 (Pappert) describes a hard-kill system based on search and track radar and launching of intercepting fragmentation or explosive grenades to destroy a threat missile.

The survivability of a LAV is further improved if the threat system relies on active sensors such as lasers or radar to improve the probability of hitting the target. Active sensors are detected by laser and radar warning receivers. The targeting system is defeated by obscuration, dazzling and evasive maneuvers. Counterfire can be used to destroy the launch platform. The time to respond to an actual or anticipated threat can be very short. The interval between detection of a laser rangefinder pulse and the firing of a main gun can be as short as one second. With only a limited amount of automation, the only reasonable response is to launch obscuration grenades in the direction of the threat and to maneuver the vehicle to a safer location.

An array of sensors and countermeasures controlled by computer resources is a defensive aids suite (DAS) for a vehicle network. It is fundamentally different from the more familiar systems developed for main battle tanks (MBTs). Main battle tanks make greater use of passive armor and are practically invulnerable to all but the most lethal threats including missiles with shaped-charge warheads and kinetic energy penetrators. When combined with MBT passive armor, the addition of a threat destruction system provides sufficient protection. Obscuration strategies have been developed for MBTs but are not suitable for light armored vehicles vulnerable to a larger number of threats and, in a peacekeeping role, susceptible to attack from any direction.

The networking of DAS-equipped LAVs has resulted in vehicle networks requiring a new approach to improving the survivability of the vehicle on the battlefield. The vehicle network DAS design must emphasize robustness through redundancy, a general purpose response to threats, expression of a “fitted for, but not fitted with” strategy, modular and integrated design, mission configurability and plug and play capability.

### BRIEF SUMMARY OF THE INVENTION

A feature of the present invention is the maximizing of the reliability of a light armored vehicle network DAS by distributing sensors on a vehicle that are also used for maneuvering and driving.

Another feature of the invention is improvement of vehicle survivability by threat detection with long-range sensors and controlling the spectral environment through laser dazzling and grenades obscuration.

Yet another feature of the invention is controlling of vehicle environment through selecting dazzling and obscuration without interference of vehicle sensors.

Another feature of the invention is the maximizing of the robustness and reliability of a vehicle network DAS by detecting threats based on sensors of different complementary technology and avoiding catastrophic loss of the DAS by distributing the sensors at various locations on a vehicle.

At short range, a threat-destroying hard-kill system will intercept a threat with fragmentation or explosive grenades guided by minimal power active sensor based on Ka-band search and track radars.

Sensors for maneuvering and driving are used for wide field of view (WFOV) hemispherical coverage. Sensors for targeting and surveillance have a similar field of regard but also a narrow field of view (NFOV). Additionally, the surveillance sensors can illuminate the targets in the sensor field of view. A laser illuminator range gated (LI/RG) camera is used to search for threat platforms based on WFOV and NFOV sensor cues.

Maximum performance of the obscuration grenade launches is achieved by including fragmentation and CS (ortho-chlorobenzal malononitrile) gas grenades in launch tubes set at three different angles to each other including 45°.

Acoustic threat detection is based on sniper detection technology extending the calculations to determine miss-distance and location to include larger caliber threats.

Radar and laser sources are detected based on radar warning receivers and HARLID®-equipped laser warning receivers as described in U.S. Pat. No. 5,428,215 by Jacques Dubois et al, thereby providing cueing information needed to locate a threat platform.

The invention communicates information from the threat destruction and avoidance systems, from the laser and radar warning receivers and from the extended acoustic sniper detection to the vehicle data bus and other vehicle resources such as the fire control system and to other vehicles in the network.

The four basic components or subsystems of the DAS include: a threat-destroying hard-kill system, a threat-avoidance soft-kill system, an acoustic threat detection system, and a system for detecting of active targeting. Information from these systems is communicated to a vehicle data bus and to other vehicles and platforms in the network.

The hard-kill system (HKS) is designed to either destroy or deflect a threat away from the vehicle. Active sensors are required to classify the threat and provide ranging data. These requirements are met by Ka-band search radar providing hemispheric coverage out to 800 m and Ka-band tracking radar mounted on two high-speed grenade launchers. The search radars are based on radar elements fixed to each corner of the vehicle turret. Completing the HKS are intercepting grenades of two types, namely blast grenades to deflect kinetic energy projectiles at 50 m and fragmentation grenades to destroy chemical energy threats at about 15 m from the vehicle. The normal configuration consists of two high-speed launchers mounted at the rear of the main turret. Each high speed grenade launcher contains a tracking radar. The launcher slew rate is 900 over 120 ms and the total system response time is 400 ms.

The soft-kill system (SKS) relies on obscurants and counter maneuvers to avoid threats. Sensors for this system detect threats at much longer ranges and are passive to avoid being detected. The passive search/track sensors are mid-infrared staring arrays providing hemispherical coverage, averaging 4096×4096 pixels for each corner of the main turret operating at 60 Hz. In the mini-turret, similar in design to the high-speed launcher mentioned above, are housed: a near field of view, mid-IR scanning array of 1024×1024 pixels with a field of view of 2.50×2.50 at 60 Hz and a laser illuminator and range-gated camera based on a near-IR scanning array, 1024×1024 pixels with a field of view of 0.5°×0.5° at 60 Hz. The NFOV array and the LI/RG camera can be used to scan for threats. Both short duration, high intensity bursts and longer duration, low intensity threat sources can be detected. The proper integration of the hard-kill and soft-kill systems is essential in maximizing the performance of the DAS. The soft-kill subsystem response includes: obscuration consisting of: passive smoke grenades based on metal-flake and chaff providing hemispherical coverage, laser dazzling can also be used safely against personnel to fill in the 1.5 s gap until full obscuration is achieved, and counter maneuvers depend on using information on the vehicle status and driver intent to select and maintain an optimum level of obscuration. The information which can be read from the vehicle bus includes (i) speed, how far to lead the grenade pattern, (ii) application of brakes or accelerator, (iii) transmission, indicating forward or reverse gear and (iv) wheel direction. Based on the nature of the threat and the vehicle bus variables the obscuration grenade choices include (i) type of grenade, (ii) the necessary pattern, and (iii) the launch point of each pattern.

Acoustic threat detection will detect muzzle blast and sound waves from a wide range of projectiles and contribute to the performance of the vehicle by locating weapons fire. Information from acoustic threat detection will also contribute to situational awareness, detecting and displaying weapons not detectable by other means. Acoustic threat detection is useful in detecting small arms fire where flash and blast has been suppressed and under battlefield conditions where smoke and dust interfere with other sensors. Generally, acoustic sensors will not outperform the hard-kill and soft-kill sensors but will contribute to overall DAS robustness by avoiding catastrophic failure from sensor loss.

Detection of active targeting relying on laser warning receivers and radar warning receivers will detect active sensors from more sophisticated weapon systems. Laser based threats including rangefinders and designators can be detected to an angular resolution of ±1 based on HARLID® technology. Laser beam-rider guidance operates at intensity levels too low for HARLID based detection but can be detected and located by sensors described in U.S. Pat. No. 5,280,167 (Jacques Dubois). Detection of radar systems also includes detection of millimeter wave (MMW) signals used by all-weather targeting systems. Both the laser warning receiver (LWR) and radar warning receiver (RWR) are used primarily for combat identification.

### BRIEF DESCRIPTION OF THE DRAWINGS

The invention is described below in greater detail with reference to the accompanying drawings, wherein:

FIG. 1 is a schematic isometric view of the defensive aids suite for light armored vehicles in accordance with the invention;

FIG. 2 is a schematic isometric view of a vehicle and a threat detection system for use on a light armored vehicle;

FIG. 3 is a schematic side view of the scanning pattern of a narrow field of view array used in the system of FIG. 2;

FIG. 4 is a graph illustrating the performance of a sniper detection subsystem extended to include acoustic energy, long range, large caliber threats; and

FIG. 5 illustrates a process of a LAV detecting a specific threat and reacting to destroy that threat.

### DETAILED DESCRIPTION OF THE INVENTION

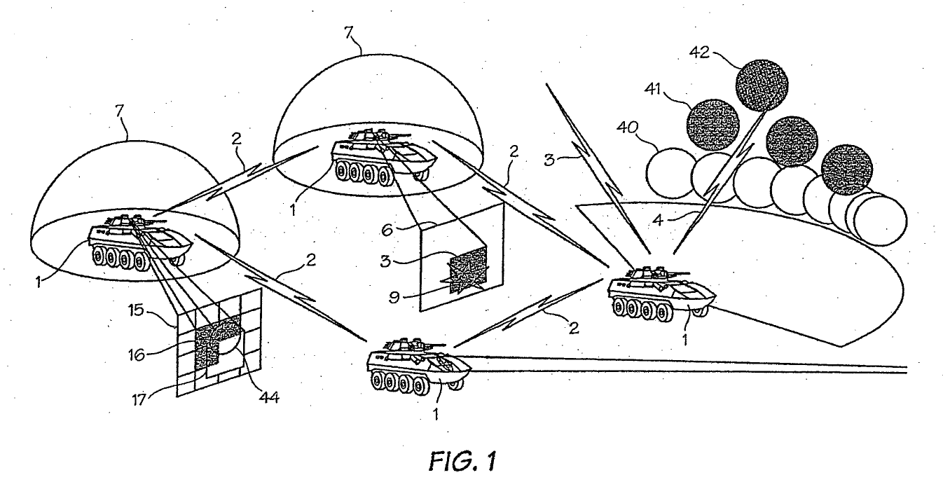

Referring to FIG. 1, the system of the present invention is intended for use with a vehicle network of four light armored vehicles 1 with (a) digital communication 2 between other vehicles 1, (b) digital communication 3 between the vehicle network and weapon systems, which can be incorporated into the vehicle network and (c) digital communication 4 between the vehicle network and other sensor platforms such as unmanned aerial vehicles (not shown). Real-time processing and communication of sensor information is shared among each of the five vehicle subsystems. A hard-kill subsystem includes (a) search radar 6 providing initial threat detection beginning about 800 m from the vehicle, (b) hemispherical coverage 7, and (c) communication 8 of the approximate location of the threat to the tracking radar, which provides improved estimates of angular and spatial position and velocity. This kinematic information is sent to the grenade launchers to launch and explode an intercepting grenade 9, which will then either deflect or destroy the threat.

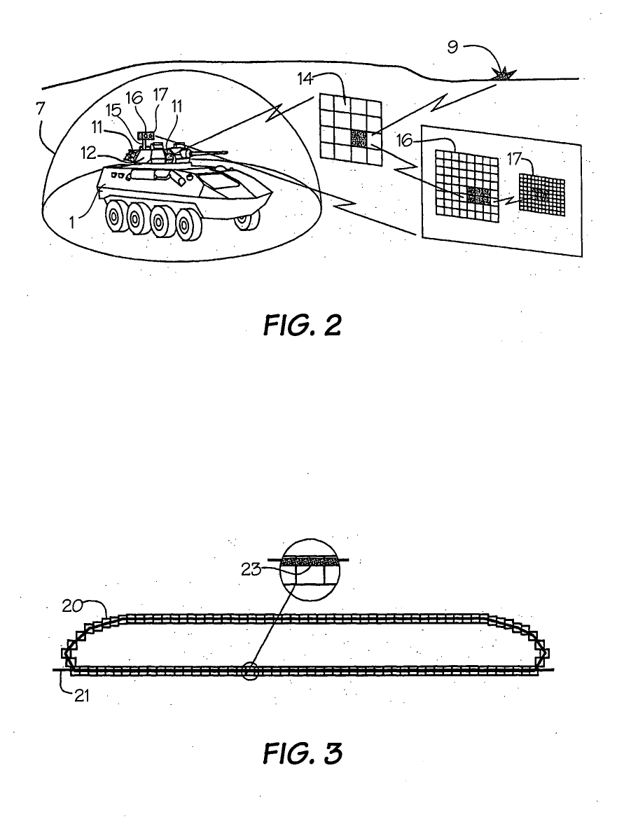

The survivability of the vehicle network is improved by long range sensing and countermeasures to avoid the threat by a threat detection sub-system (TDS) and a soft-kill subsystem. As best shown in FIG. 2, the TDS includes four wide field of view (WFOV) infrared starring arrays 11 mounted on the corners of the main turret 12 of each light armored vehicle 1. The arrays 11, which average 4096×4096 pixels, provide hemispherical coverage (indicated by the dome 7) at a relative low spatial resolution. At practical ranges, most threats have dimensions occupying less than one pixel 14.

A signal from the WFOV arrays 11 is used to slew, at a rate of 720° a second, a mini-turret 15 carrying a narrow field of view (NFOV) mid-IR array 16 and a third optical device in the form of a camera 17. The NFOV array 16 is a mid-infrared 1024×1024 pixel array with a field of view of 2.5°×2.5°. The camera 17 is a laser illuminated and range gated (LI/RG) camera based on a near-infrared, 0.8 μm, 1024×1024 pixel array with an even narrower field of view of 0.5°×0.5°. The relationship between the NFOV array 16 and the camera 17 is fixed, and is used to refine the pointing direction and guide the camera 17 to the threat direction. The net result is that the combination of the three optical system are used in proper sequence to detect a threat 19, refining the threat direction progressively from hemispherical coverage to an instantaneous field of view of less than 10 μrad.

Optical detection performance requires all three optical systems. However, when the WFOV arrays 11 are not available or the infrared signal is too low, it is possible to use the mini-turret optics to scan for threats. Scanning is carried out for both land-based missile launches and in-flight missiles. Based on the 60 Hz frame rate of the NFOV array 16, a scanning pattern 20 (FIG. 3) is constructed from individual frames. The pattern and scan time are limited to about 2 seconds based on the boost phase of a typical anti-tank guided missile (ATGM). Therefore, a 1350 scan along the horizon 21, followed by a similar return scan of the sky at an elevation of 15° can be completed in less than 2 seconds.

The relationship 23 between the aiming of the two optical systems 16 and 17 on the mini-turret 15 is illustrated in FIG. 3. The field of view of the LI/RG camera 17 is contained in the NFOV of the IR system. During the horizon scan the camera is aimed at either the horizon 21 or at a virtual point 5 km from the vehicle 1. Few direct-fire weapons have ranges exceeding 5 km. In complex or hilly terrain, initial threat detection can be carried out more efficiently by the WFOV arrays 11.

The threats to a vehicle rely on chemical propulsion either to deliver a warhead or to generate sufficient kinetic energy to damage or destroy the target. In general, threats to a vehicle 1 include anti-tank guided missiles (ATGMs), missiles or rounds from large-caliber guns (125 mm) including a chemical energy warhead and a kinetic energy penetrator, respectively, and rounds from smaller (30 mm) guns firing a 30 mm round or a 14.5 mm round, respectively. The side-discharged plumes from some missiles have small underexpanded flows and are therefore relatively difficult to detect. By contrast, the rocket exhaust from an ATGM is fully expanded resulting in larger plumes, which are detectable at longer ranges. Some missiles rely on launch, boost and flight motors to attain the necessary velocity, while other missiles are all-burnt-on-launch devices.

Table 1, which follows, provides distance at which named vehicle threats can first be detected by WFOV arrays 11 under favorable conditions. Detection of the threats by the NFOV array 16 under more adverse conditions and by the camera 17 is also provided in the Table 1.

TABLE 1
SEARCH AND TRACK PERFORMANCE

| | IR WFOV | IR NFOV | LI/RG Camera | | | |
|---|---|---|---|---|---|---|
| | 90° × 90° | 2.5° × 2.5° | 0.5° × 0.5° | | | |
| Anti-Armor | 4096 × 4096 | 1024 × 1024 | 1024 × 1024 | | Threat Variables | |
| Threat | Distance | Distance | Threat | Target | Range | Velocity |
| Type | m | m | pixels | pixels | m | m/s |
| MISSLE 25 | 400 | 3600 | 1.3 | 25 × 20 | 14000 | 255 |
| ATGM 26 | 4770 | 7740 | 79 | 90 × 30 | 4000 | 175 |
| ATGM 27 | 1640 | 3050 | 7 | 70 × 23 | 5000 | 255 |
| ATGM 28 | 3500 | 5400 | 254 | 235 × 78 | 1500 | 270 |
| ATGM 29 | 3180 | 3750 | 7 | 64 × 21 | 5500 | 210 |
| ATGM 30 | 9410 | 12200 | 200 | 94 × 31 | 3750 | 235 |
| RPG 31 | 470 | 4200 | 1385 | 234 × 187 | 500 | 255 |
| RPG 32 | 470 | 4200 | 531 | 146 × 117 | 800 | 300 |
| RPG 33 | 8600 | 1500 | 1075 | 586 × 469 | 200 | 95 |
| GUN 34 | 17200 | 3050 | 16 | 90 × 30 | 4000 | 775 |
| GUN 35 | 17200 | 700 | 4 | 118 × 60 | 2000 | 1450 |
| GUN 36 | 5480 | 700 | 4 | 118 × 60 | 2000 | 815 |
| GUN 37 | 5480 | 340 | 0.8 | 118 × 60 | 2000 | 815 |

The missile 25 is fired by artillery from as far away from the target vehicle as 14 km. The blast can be detected by the WFOV arrays 11 at the maximum range. The missile 25 can be detected by the NFOV array 16 at 3600 m then classified and tracked by the LI/RG camera 17 fourteen seconds from the vehicle 1. If the missile launch is not detected, the missile can still be detected by an IRST scan. Detection is also possible by the WFOV arrays 11 at 400 m, 1.5 s from the vehicle.

The anti-tank missiles (ATGMs) 26 to 30 are guided to the target. To avoid interference with missile guidance a clean-burning propellant is used and the rocket exhaust is diverted through two nozzles on either side of the missiles. Detection of these missiles depends primarily on detection of the exhaust plumes, by using infrared sensors, at ranges up to 5500 m.

ATGM 26 is a missile relying on wire guidance to correct the flight path relative to an infrared beacon at the back of the missile, but can be guided manually if jamming is suspected. A boost motor increases the velocity to about 108 m/s and a maximum range of 4000 m is achieved in about 19 s. A newer version of this missile allows the operator to switch to a manual mode if optical jamming is detected. The missile can be detected by the NFOV array 16 at any practical range from the vehicle and by the WFOV arrays 11 by 900 m, 5 s from the vehicle.

ATGM 27 is a missile launched from a 125 mm tank gun and guided to the target by laser. The missile 27 is a laser-beam rider launched from the tank gun. The maximum range is 500 m. Detected by the initial blast, the missile 27 can be tracked by the LI/RG camera 17 over the full range. The missile 27 can also be detected by NFOV array 16 by 3050 m, 12 s from the vehicle 1 and by the WFOV arrays 11 by 330 m, 1.3 s from the vehicle 1.

ATGM 28 is a wire-guided missile using a pyrotechnic flare as an infrared beacon. The boost velocity is 200 m/s and the maximum range is about 1500 m. The missile is susceptible to countermeasures including false beacons and wide-area active smoke. It can be detected by the NFOV array 16 at any practical range from the vehicle 1 and with the WFOV arrays 11 by 600 m, 3.5 s from the vehicle 1.

The ATGM 29 is a missile relying on a laser signal to guide the missile over a maximum range of 5500 m. The boost velocity is estimated to be 225 m/s. It can be detected by the NFOV array 16 by 3750 m, 18 s from the vehicle and by the WFOV arrays 11 by 400 m, 1.9 s from the vehicle 1.

ATGM 30 is a missile relying on a xenon beacon for guidance to the target, and therefore, is not susceptible to false beacon jamming. The missile can be susceptible to wide-area active smoke if the intensity is sufficiently high and noisy. The missile 30 can be detected by the NFOV array 11 at any range from the vehicle 1 and by the WFOV arrays 11 by 1360 m, 5.8 s from the vehicle 1 while under boost or with the reduced intensity level in post burnout flight by 400 m, 1.7 s from the vehicle, with the WFOV arrays 11.

Rocket propelled grenade (RPG) 31 is a generic rocket propelled grenade with a typically short range and high subsonic velocity sustained over the entire flight. The destructive power is produced by a shaped-charge warhead. It can be detected by the NFOV array 16 at any range and with WFOV arrays 11 by 500 m, 1.0 s from the vehicle 1. Scanning the battlefield with the LI/RF camera 17 on active will also detect the shooter through retroreflection.

RPG 32 is similar to RPG 31 above but a smaller caliber. The range is also longer at 800 m. It can be detected by NFOV array 16 at any range and with WFOV arrays 11 by 500 m, 1.0 s from the vehicle 1.

The RPG 33, unlike the other two RPGs, is based on a propellant designed to burn completely during launch. The grenade launch produces a high intensity short duration flash that is easily by the WFOV arrays 1. The grenade itself can be detected by the NFOV array 16 at the maximum range of 200 m. With an average velocity of 95 m/s, the flight time is 2.1 s.

Gun round 34 is 125 mm caliber, high energy, anti-tank (HEAT) round. The blast can easily be detected by the WFOV arrays 11. The projectile can also be detected by NFOV array 16 at 3050 m, 4 s from the vehicle 1. The LI/RG camera 17 can be used to track the round over the full range.

Gun round 35 is a 125 mm caliber armor-piercing fin-stabilized discarding sabot (ADFSDS) round. The NFOV array 16 and the camera 17 can be used to provide more precise information for a hard-kill system.

Gun round 36 is a 30 mm round. Detection of the blast by the WFOV array 11 can be used to slew the NFOV array 16 and the projectile is then tracked by the camera 17.

Gun round 37 is a 30 mm armor-piercing discarding sabot (APDS) round. The difference is that the subbore projectile is smaller and is therefore more difficult to track.

Countermeasures used by the soft-kill subsystem are needed to disrupt aiming or targeting of the vehicles through the use of dazzling and obscuration. Laser dazzling is intended to disrupt observing the vehicle or aiming a weapon directed at the vehicle. The dazzling laser is mounted in the mini-turret 15 and will also compensate for the time delay needed to achieve full obscuration. The obscuration grenades will defeat targeting and missile guidance with ground screens, top-attacking weapons with mid-level screens and sensor-fused submunitions with overhead obscurant screens. The performance of these subsystems is further improved by extending the capabilities of a sniper detection systems to include a wide range of threats. Acoustic threat detection is located on the LAVs. A more complete threat detection suite is possible by including the detection of active targeting systems. Detection is carried out by laser warning receivers (LWRs) detecting rangefinders, designators and beamrider missile guidance. Radar and millimeter wave (MMW) sources are detected with radar warning receivers.

As shown in FIG. 1, the soft kill subsystem relies on countermeasures based on obscuration grenades. Grenades bursts occur at three heights to defeat a wide range of threats, including a ground screen 40 at 20° to counter most ATGMs, a mid-level screen 41 at 450 to defeat aircraft-launched missiles, and a high level screen 42 at 700 to avoid sensor-fused submunitions. The spectral range varies from visible-only, to avoid interference with vehicle infrared optics, to a maximum obscuration of infrared and millimeter wave optics. Consistent with the peacekeeping role in complex terrain the grenades provide hemispherical coverage. To minimize interference with vehicle optics the radius of the ground screen 40 is set at 40 m. The grenades have a time delay of 1.5 s during which laser dazzling 44 (FIG. 1) can be used until full obscuration is achieved. The required burst height and time delay depends on a launch velocity of 25 m/s. Cold temperature operation results in a reduction of the launch velocity from 25 to 20 m/s. This loss of burst height can be regained by tilting the launchers up by about 10°.

The exchange of information between the stand-alone hard-kill system and the remaining suite of vehicle sensors and countermeasures are listed on Table 2

TABLE 2
SOFT-KILL RESPONSE TO HARD-KILL SENSOR IN FORMATION

| HARD-KILL SENSOR INFORMATION | | SOFT-KILL COUNTERMEASURES |
|---|---|---|
| Angle of Attack | Velocity Range | Threat Assumption and Response |
| Greater than 30° | Greater than 700 m/s | Long-range Missile or Aircraft-launched |
| | | 2 s IRST for threat platform |
| | | mid-level obscuration and countermanoeuvres |
| | | counterfire on detection |
| | Less than 700 m/s | Wide-Area Munition, Sensor-Fuzed |
| | | Submunition, |
| | | Artilery launched Missile, Top-attack ATGM |
| | | scan for threat |
| | | all-level obscuration and countermanoeuvres |
| | | counterfire on detedtion |
| Less than 30° | Greater than 700 m/s | Direct Fire Weapon |
| | | 2 s ranged-gated scan for threat platform |
| | | ground obscuratin and countermanoeuvres |
| | | counterfire on detection |
| | Less than 700 m/s | Precision Guided Missile or Rocket Propelled |
| | | Grenade |
| | | scan for threat |
| | | counterfire on detection |

Ideally, the long-range soft-kill subsystem will detect and help avoid a threat obviating the need to use the hard-kill subsystem. However, Table 2 represents the less common situation where the threat is detected and destroyed by the hard-kill subsystem and through proper integration is able to communicate the threat angle-of-arrival and velocity information. This information is essential to launching the intercepting grenade and is therefore readily available.

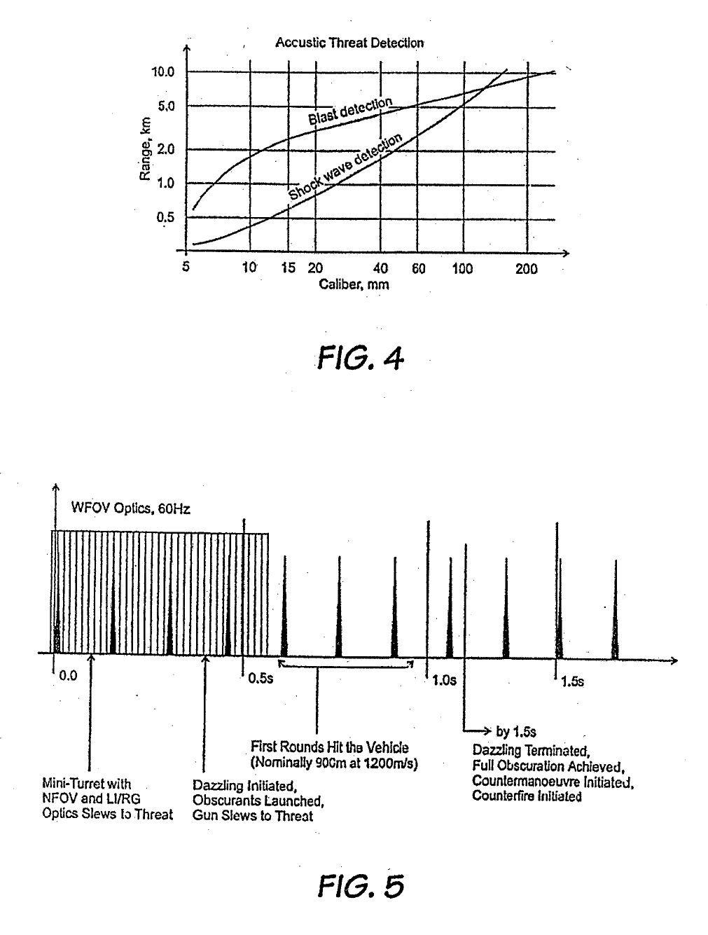

FIG. 4 represents the typical performance of the sniper detection system extended to include a wide range of calibers. Acoustic threat detection is used to detect muzzle blast and the sound wave produced by the shockwave.

FIG. 5 represents the typical response of the defensive aids suite to an automatic weapon. The muzzle blast is detected with the WFOV optics. The mini-turret slews towards the threat, and dazzling is initiated while the obscuration grenades are launched. The platform is detected, with the NFOV optics, and the information is communicated to the Fire Control System, which slews the main gun towards the platform. Once full obscuration is achieved the vehicle is maneuvered away from the threat and counterfire is used to eliminate the threat platform.

Various modifications may be made to the preferred embodiments without departing from the spirit and scope of the invention as defined in the appended claims.

1. A defensive aids suite for protecting a light armored vehicle from threats comprising search and track radar means and high-speed grenade launchers on a main turret of the vehicle for launching intercepting grenades.

2. The defensive aids suite of claim 1, wherein the grenades include blast grenades and fragmentation grenades.

3. The defensive aids suite of claim 1, wherein the search radar means are radar elements fixed to each corner of the turret.

4. The defensive aids suite of claim 1, wherein the track radar means are radar elements fixed to each high speed grenade launcher.

5. The defensive aids suite of claim 1 including a threat sensing sub-system comprising wide field of view sensors on the main turret having mid-infrared starring arrays providing hemispherical coverage to detect threats at a distance.

6. The defensive aids suite of claim 5 including grenade launchers positioned on the main turret to launch obscuration grenades at fixed angles of 20°, 45° and 70° with respect to the main turret.

7. The defensive aids suite of claim 1 including a mini-turret on said main turret, and a first narrow field of view IR sensor array on said mini-turret adapted to be slewed towards a threat by signals from the wide field of view sensor.

8. The defensive aids suite of claim 7 including a second narrow field of view IR sensor array having a field of view narrower than that of the first narrow field of view sensor array on the mini-turret with a field of view fixed with respect to the first narrow field of view sensor array.

9. The defensive aids suite of claim 1 including laser warning receivers on said vehicle.

10. The defensive aids suite of claim 1 including radar warning receivers on said vehicle.

11. The defense aids suite of claim 1 including an acoustic threat detection apparatus on said vehicle.
